(19) United States
(12) Patent Application Publication
(10) Pub. No.: US 2025/0119360 A1
(43) Pub. Date: Apr. 10, 2025

(54) Counterfactual and Recourse Method for Recommending Network Configurations towards Favorable Outcome

(71) Applicant: Telefonaktiebolaget LM Ericsson (publ), Stockholm (SE)

(72) Inventors: Arun Mathew Kunnumpurath Jacob, Athlone (IE); Ashwin Raghavan, Athlone (IE); James O'Meara, Athlone (IE); Paddy Farrell, Athlone (IE); Premnath Kandhasamy Narayanan, Athlone (IE)

(21) Appl. No.: 18/836,607

(22) PCT Filed: Feb. 10, 2022
(86) PCT No.: PCT/EP2022/053279

§ 371 Date: Aug. 7, 2024

(51) Int. Cl. H04L 41/16; G06F 18/243; H04W 24/02

(52) U.S. Cl. CPC H04L 41/16; G06F 18/24323; H04W 24/02

(57) ABSTRACT

A method for improving communication network performance comprises identifying a favorability status of individual predictions and/or decisions of a plurality of decisions of a machine-learning algorithm acting on the communication network. The favorability statuses are stored with corresponding values of network parameters used as features in the algorithm. A counterfactual algorithm is generated, e.g., by generating a tree-based classification algorithm, based on the stored favorability statuses and network parameter values, to derive rules for producing a favorable status based on one or more of the network parameters. A proposed recourse action comprising a change in at least one of the network parameters is identified, based on the rules, and a decision network, such as a Bayesian inference network, is generated for determining a confidence level estimating a reliability of achieving a favorable status by changing the network parameter(s). Whether to implement the proposed recourse action is determined, based on the confidence level.

### TECHNICAL FIELD

This disclosure is generally related to communications networks and machine learning, and is more particularly related to techniques for improving network performance, using machine learning.

### BACKGROUND

Wireless telecommunication networks are configured to run with best performance by using correct configuration parameters (CM), which may be set and/or tuned to address varied cell sizes, deployment topographies, traffic load patterns, etc. Different configurations induce different behavior in the network, ideally to optimize network throughput, minimize interference and dropped/interrupted calls or data sessions, and otherwise optimize user experience. Normally, the parameters are configured based on guidelines provided by the respective network vendors for running the networks effectively.

In recent years, machine-learning algorithms have been applied to the problem of optimizing communication network performance. Network data such as the configuration management (CM) parameters discussed above, performance management metrics, and network events from event logs and alarms may be used as input parameters for machine-learning algorithms. These machine-learning algorithms act as generalized models for the respective networks, and can provide specific outputs for the given input data, based on the data patterns perceived by the algorithms.

The machine-learning algorithms can be used to generate predictions with respect to a specific target. Different types of these algorithms, such as classification algorithms, regression algorithms, clustering algorithms, etc., answer different sorts of questions and may each be most suitable for particular sorts of predictions. In the context of a communication network, the various types of machine-learning algorithms might answer questions of the sorts shown in Table 1, below:

TABLE 1

| | Machine-learning |
|---|---|
| Business Question | algorithm type |
| Is this A or B? | Classification |
| E.g.: Is this a macro cell or a small cell? | |
| Is this unusual? | Anomaly |
| E.g.: Is it not unusual to see high power consumption | Detection |
| like this, with low traffic? | |
| How much/how many? | Regression |
| E.g.: How loaded will the cell be? How many cells | |
| can be put to sleep, based on the traffic? | |
| How is this organized? | Clustering |
| E.g., How are network cells organized based on a | |
| specific parameter, such as cell range? | |
| What action should be taken next? | Reinforcement |
| E.g.: Should an antenna be tilted? Should power be | Learning |
| reduced? Should a cell be put to sleep? | |

Machine-learning algorithms are generally opaque to the end customer, e.g., the network operator, and the model instantiated by the machine-learning algorithm is hidden from the end customer. The concept of “Explainable AI” (xAI) has been introduced to provide additional insights, to the end customer, about how the input parameters are influencing a particular decision. As an example, the bar chart illustrated in FIG. 1 indicates how each of various input parameters, which are “features” of the machine-learning algorithm, are influencing the target parameter, which in this example is a power consumption metric. This sort of analysis is generally referred to as feature impact analysis.

In this example, the biggest influencers of the power consumption, at the time the analysis was run, is the number of users connected to the network. Lesser influences, in order, include total radio utilization, the number of configured transmit antennas, configured transmitter powers, the number of handover (HO) failures in a monitored period, and the number of too- late HOs in a monitored period. There might be dependent plots available for each feature, reflecting in further detail how the feature influences the target.

Thus, machine-learning (ML) algorithms help to make decisions based on complex input data, while xAI helps to understand the rationale behind the decisions or predictions made by the machine-learning algorithms. However, the decision or prediction made by the algorithm may not be favorable, with respect to the end customer's expectation. Further, the machine-learning algorithms output generally provides no indication of what should be done by the end customer to get a desired favorable outcome. An end customer can address this indirectly, by changing inputs to the algorithm to see how its decisions or predictions vary. But, this simply forces the algorithm to answer specific individual questions, such as what happens to power consumption if the HO failures are reduced, or if the configured power metric is changed from 30 to 28. For a complex system with many configuration parameters, this may amount to simply making guesses.

### SUMMARY

Various embodiments of the techniques and systems described herein address this and other problems by implementing a counterfactual and recourse method for recommending network configurations towards a favorable outcome. This approach helps the system progress towards a favorable outcome, rather than just providing a plain outcome (e.g., a prediction for given instance data).

The counterfactual aspect of these techniques prescribes feature rules for favorable outcomes, based on network input data and previous decisions made by the machine-learning algorithm. The recourse aspect of these techniques checks the reliability or certainty of these feature rules, so that recourse actions taken by or performed on the system move the system towards a favorable state, from a current unfavorable state.

An example method for improving communication network performance according to some embodiments of the techniques described herein comprises identifying a favorability status of individual predictions and/or decisions of a plurality of predictions and/or decisions of a machine-learning algorithm acting on at least a portion of the communication network, and storing said favorability statuses along with corresponding values of network parameters used as features in the machine-learning algorithm. The example method further comprises generating a counterfactual algorithm, e.g., by generating a tree-based classification algorithm, based on the stored favorability statuses and corresponding values of network parameters, to derive rules for producing a favorable status, based on one or more of the network parameters. The method still further comprises identifying a proposed recourse action comprising a change in at least one of the network parameters, based on the derived rules in the counterfactual algorithm, generating a decision network and determining a confidence level estimating a reliability of achieving a favorable status by changing the at least one network parameter, and determining whether to implement the proposed recourse action on the communication network, based on the confidence level.

Variations of this technique and systems as well as processing nodes for implementing this and other techniques are described in further detail below. These recourse-based techniques and systems as well as processing nodes help a communication network or other modeled system to progress towards a favorable outcome, rather than just providing a simple informational outcome (e.g.: prediction for given instance data. These techniques provide a progressive and recourse-oriented approach, compared to current state of the art reinforcement learning (RL). In the case of RL, actions are performed on the environment, based on its past action's feedback (success or failure). The counterfactual methods described herein, on the other hand, use existing knowledge of the machine-learning model for feature-level recourse.

Other advantages and uses of the techniques and systems will be apparent from the attached figures and the detailed description that follows.

### BRIEF DESCRIPTION OF THE FIGURES

FIG. 1 is an illustration of feature impact scores produced by explainable artificial intelligence (xAI).

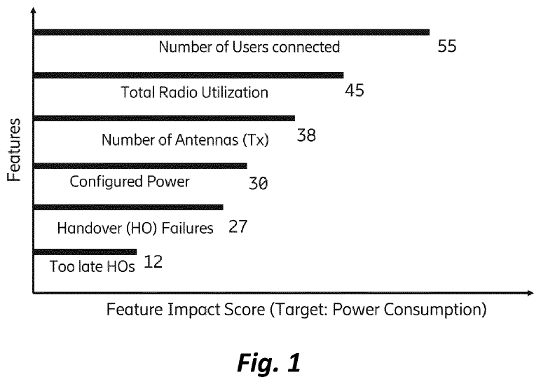

FIG. 2 illustrates a system in which a counterfactual and recourse (CFR) method monitors a machine-learning algorithm.

FIG. 3 illustrates the overall algorithm flow for a CFR method.

FIG. 4 shows an example counterfactual decision tree.

FIG. 5 shows details of an example Bayesian inference network.

FIG. 6 is a block diagram illustrating an example CFR apparatus with Auto-CFR module.

FIG. 7 is a process flow diagram illustrating an example method according to some of the presently disclosed techniques.

FIG. 8 is a block diagram showing an example processing node for carrying out one or more of the presently disclosed techniques.

FIG. 9 shows cloud implementations of CFR methods.

FIG. 10 illustrates a virtualization environment, in which parts of or all of any of the techniques disclosed herein may be implemented.

### DETAILED DESCRIPTION

As discussed briefly above, every machine-learning algorithm answers a specific business question based on its input data, whether or not the decision or prediction provided by the machine-learning algorithm is favorable to end user or system. These algorithms provide no counter-factual prescription on features, e.g., to indicate what should be done by the end user to get favorable outcome from the system The algorithms include no recourse methods to ensure the algorithm results are towards favorable results for the end user or system.

New data privacy regulations, such as the European General Data Protection Regulation (GDPR) and other government regulations, are expecting machine-learning algorithms to reason out the rationales behind various business processes (e.g., loan or insurance denial or not issuing postpaid connection to a subscriber) and provide prescriptive recommendations for favorable outcomes. Currently, any such capability is there only by design, with current state of the art machine learning algorithms.

In addition, machine-learning algorithms are stochastic in nature and are prone to data biases, and could provide malicious results, albeit unintentionally, e.g., for a smaller inference data set. This may be due to the use of a generalized model by design, to avoid over fitting and under fitting. The outcome of such stochastic algorithms may not be favorable to the end consumer (e.g.: end user or system).

Machine-learning algorithms are generally opaque, providing no information about how they are making decisions. With newer, state-of-the-art, xAI algorithms, the rationale behind the decision may be explainable, but not to the extent of counter-factual prescriptions on algorithm features and recourse plans. Note that the term “recourse” here refers to the ability of the user or system to take action to change the modeled system's behavior to move the behavior in a more favorable direction.

The techniques described herein are directed to what might be called a counter-factual and recourse (CFR) method. The “counter-factual” portion of the CFR method involves the monitoring of a machine-learning algorithm's output and the use of tree-based models, for example, to prescribe actionable feature changes (as rules) that will allow the system to achieve favorable outcome in the future. The “recourse” portion of the CFR method checks the reliability (or certainty) of actionable feature changes, using Bayesian inference, for example, and approves the recourse actions in the system that the end user or the system can further apply, for a favorable outcome.

The CFR methods described herein can be applied to any of the sorts of machine-learning algorithms discussed in the Background section above, to obtain deeper insight into the modeled system's behavior and to get prescriptive recommendations for action to achieve favorable outcomes. Table 2 illustrates the role the CFR methods described herein may play when coupled with machine-learning algorithms of various types.

TABLE 2

| | Machine- | |
|---|---|---|
| | learning | Role of Counterfactual |
| | algorithm | Recourse Method, with |
| Business Question | type | Examples |
| Is this A or B? | Classification | Classification algorithm can |
| E.g.: Is this a macro | | classify the inference data |
| cell or a small cell? | | (e.g., congested or not |
| | | congested cell). When the |
| | | intention of the system is to |
| | | find out what it takes to avoid |
| | | congestion, learning only that |
| | | a cell is congested does not |
| | | provide a favorable response. |
| | | Counterfactual recourse |
| | | provides a prescriptive value |
| | | that can indicate what it takes |
| | | to reduce congestion, e.g., by |
| | | changing a cell configuration. |
| | | For example, the CFR method |
| | | may prescribe an increase in |
| | | QrxLevMin, i.e., the minimum |
| | | signal level for camping on a |
| | | cell. |
| Is this unusual? | Anomaly | An anomaly detection (AD) |
| E.g.: Is it not unusual | Detection | algorithm detects anomalies in |
| to see high power | | the system, such as high power |
| consumption like | | coupled with low traffic. xAl |
| this, with low traffic? | | may help explain the reason for |
| | | high power (e.g., high |
| | | interference). The CFR method |
| | | may be used to find a recourse |
| | | to correct the interference |
| | | problem. For example, the CFR |
| | | method may prescribe the |
| | | performing of a down-tilt of |
| | | specific cells in the network to |
| | | reduce interference, that in turn |
| | | solves the anomaly. |
| How much/how | Regression | Regression can predict a future |
| many? | | value or unknown value of a |
| E.g.: How loaded | | specific target, such as load of a |
| will the cell be? | | cell. A high load value may be |
| How many cells can | | unfavorable. CFR can prescribe |
| be put to sleep, | | what it takes to run the cell on |
| based on the traffic? | | optimal load, e.g., by changing |
| | | coverage footprint. |
| How is this | Clustering | A clustering algorithm shows |
| organized? | | how the network is organized, |
| E.g., How are | | e.g., based on a specific set |
| network cells | | parameter like cell range. CFR |
| organized based on | | can prescribe what it takes to |
| a specific parameter, | | run the cells with optimal range, |
| such as cell range? | | e.g., by changing coverage |
| | | footprint. |
| What action should | Reinforcement | Reinforcement learning can |
| be taken next? | Learning | suggest a next best possible |
| E.g.: Should an | | action to the environment, based |
| antenna be tilted? | | on available knowledge (e.g., |
| Should power be | | based on Markov decision |
| reduced? Should a | | chains). CFR can use different |
| cell be put to sleep? | | combinations of the existing |
| | | algorithm and propose a |
| | | prescription that goes beyond |
| | | available knowledge. |

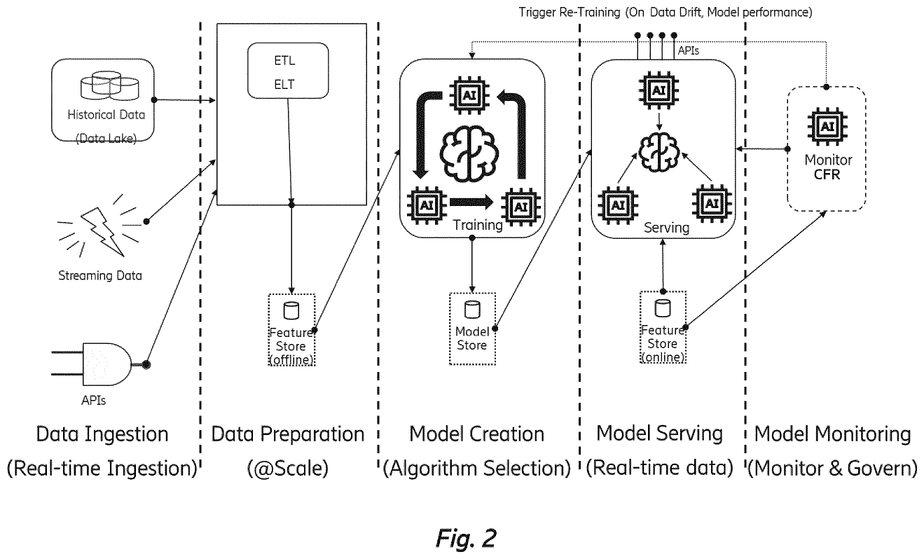

FIG. 2 illustrates an example of an implementation of the counterfactual and recourse (CFR) method in the context of monitoring a machine-language model. As shown in the figure, modeling of the system begins with data ingestion, which may be real-time ingestion. This may be historical data, e.g., in a “data lake,” or streaming data, representing real-time input. Well-known extract, transform, and load (ETL) or extract, load, and transform (ELT) processes may be used to pre-process the data. From this, a feature store is created. Next, as seen in the figure, the machine-learning model is created. This includes algorithm selection and training of the model. Once created, the machine-learning algorithm can begin processing real-time data, to provide predictions or decisions according to the model type (classification, regression, etc.)

According to the techniques described herein, the machine-learning algorithm is supplemented with a CFR method, which, as described in further detail below, monitors and governs the machine-learning algorithm.

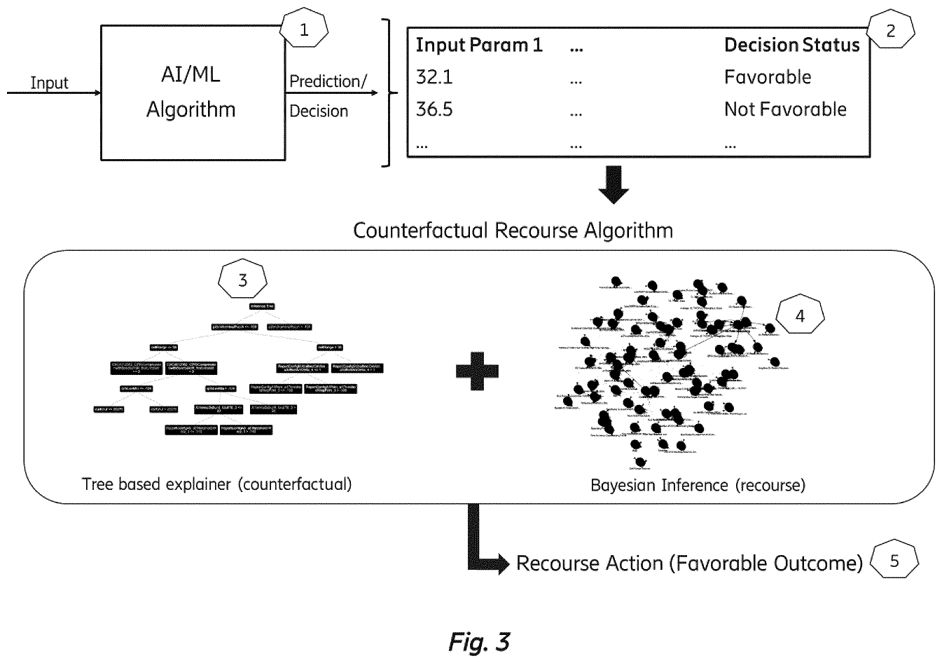

FIG. 3 illustrates more detailed components of an example CFR implementation.

As seen at the top left of the figure, at (1), an artificial-intelligence/machine-learning algorithm makes predictions and/or decisions based on a trained model, which may be any of the sorts discussed above, e.g., regression, classification, etc. As shown at (2), the predictions (AI/ML algorithm output) are captured over time and stored with what might be referred to as a favorability status, shown in FIG. 3 as a column labeled “Decision Status,” in which each prediction or decision is labelled as “Favorable” or “Not favorable,” e.g., based on end-user feedback. The favorability status may be listed as “favorable” when the decision or prediction made by the AI/ML algorithm in step (1) is towards the intended state for the system or end user, and “not favorable,” otherwise. For the purposes of this document, the terms “favorability status” or “decision status” should be understood as referring to an indication of a degree of favorability for a prediction, decision, or other output of the machine-learning algorithm, e.g., a degree of closeness to one or more ideal values or ranges of values for one or more metrics or states characterizing the system. That indication might be a binary one (“unfavorable” vs. “favorable”), as in the example shown in FIG. 3, or a ranking or score, e.g., favorability ranked on a scale of 0-10.

Next, as shown at (3) in FIG. 3, a tree-based counterfactual algorithm generates rules (for target as “Decision Status”), using the table generated from step (2). Details of tree-based algorithms that produce counterfactual rules for one or more input features are discussed further, below. These rules are based on the model features. An example rule may specify that a value for a certain feature of the model should be increased or decreased, relative to its current value, or set to a particular value, different from its current value, to achieve a favorable outcome or to steer the model towards a favorable.

Next, as shown at (4) in FIG. 3, a Bayesian inference-based recourse algorithm or, more generally, a decision network-based recourse algorithm, is used to assess a confidence or reliability of one or more actions predicted by the rules, to ensure that the rules generated by counterfactual algorithm in step (3) yield intended results on the network with a high certainty. This confidence or reliability might be indicated by a probability score, for example.

Finally, as shown at (5) in FIG. 3, the system or end user can apply one or more recourse actions that have a high confidence or reliability. This may involve, for example, evaluating the confidence against a threshold, and only applying a recourse action associated with a confidence score above the threshold, or above or equal to the threshold.

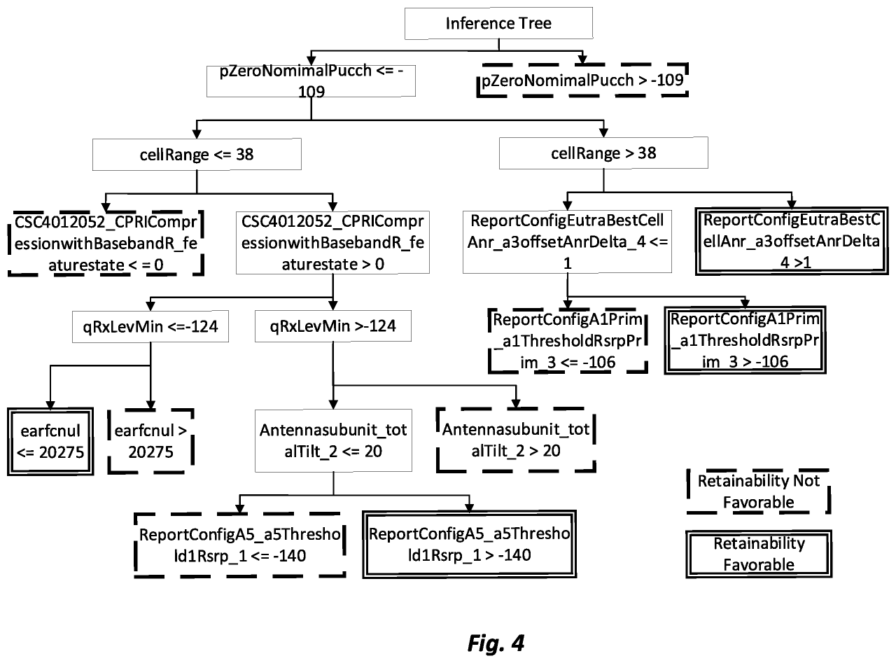

FIG. 4 illustrates example details of a tree-based classification algorithm employed as a counterfactual algorithm.

A tree-based classifier algorithm, such as the well-known C4.5 statistical classifier algorithm, can generate rules like those shown in FIG. 4, based on information gain in the tree split. The counterfactual algorithm performs the rule derivation using information gain associated with specific features of the model. Information gain is derived before and after a transformation (data split with rules) by comparing the entropy values. Information gain is achieved when the entropy values is reduced in the dataset after a split of the tree. Such rules clearly indicate which features lead to favorable outcomes and which do not. When the current outcome of the AI/ML algorithm is not favorable, the counterfactual algorithm's favorable rules can be used for further recourse.

In the illustrated example the counterfactual algorithm predicts rules for favorability with respect to a key performance indicator (KPI) called “Retainability,” where favorability is assessed by comparing the retainability KPI to a certain threshold, e.g., 90%.

Here, retainability is defined in terms of several input parameters to the underlying machine-learning model of the communications network as:

$$Retainability ( \% ) = 100 \times ( 1 - \frac{pmErabRelAbnormalEnbAct + pmErabRelMmeAct}{\begin{matrix}pmErabRelAbnormalEnb + \\ pmErabRelNormalEnb + pmErabRelMme\end{matrix}}$$

The counterfactual tree may be generated using the C4.5 statistical classifier machine-learning algorithm, for example, using as training data a data set that includes sets of input parameters for the ML model of the network, each set corresponding to a particular modeled instance of time, along with corresponding “favorable” and “unfavorable” outcomes. In this example, the features of the decision tree, taken from the ML model of the network, are shown in Table 3.

TABLE 3

| Parameter | Description |
|---|---|
| pZeroNominalPucch | Nominal component of UE transmit |
| | power for Physical Uplink Control |
| | Channel (PUCCH) |
| cellRange | Intersite distance based on neighbor |
| | relation distance |
| CXC4012052_CPRICompression | “CPRI compression” license |
| withBaseBandR-featurestate | activation status |
| ReportConfigEUtraBestCellAnr_ | Offset value for eventA3 |
| a3offsetAnrDelta_4 | |
| qRxLevMin | Required minimum received |
| | Reference Symbol Received Power |
| | (RSRP) level in E-UTRA frequency |
| | for cell reselection |
| ReportConfigA1Prim_a1 | RSRP threshold value for primary |
| ThresholdRsrpPrim_3 | eventA1 |
| earfcnul | Channel number for central UL |
| | frequency |
| AntennaSubunit_totalTilt_2 | Total antenna elevation including |
| | installed tilt and tilt applied by remote |
| | electrical tilt |
| ReportConfigA5_a5Threshold | RSRP threshold1 value for eventA5 |
| 1Rsrp_1 | |
| pmErabRelAbnormalEnbAct | Total number of abnormal E-RAB |
| | releases per cell initiated by the eNB |
| | where there was data in either uplink |
| | or downlink buffer |
| pmErabRelAbnormalMmeAct | Total number of E-RAB releases |
| | initiated by the MME considered as |
| | abnormal |
| pmErabRelAbnormalEnb | Total number of abnormal E-RAB |
| | releases triggered by eNB per cell |
| pmErabRelNormalEnb | Total number of normal E-RAB |
| | releases triggered by eNB per cell |
| pmErabRelMme | Total number of E-RAB releases per |
| | cell initiated by the MME excluding |
| | successful handover |

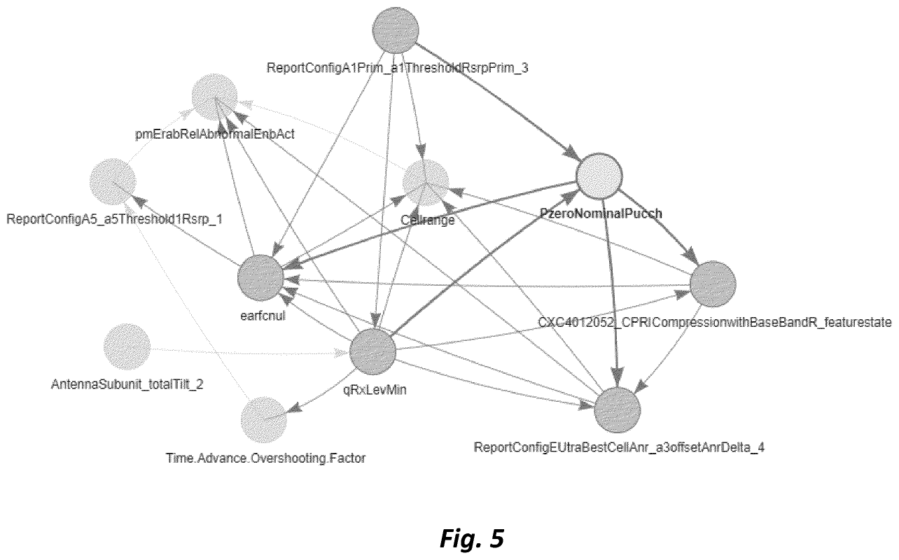

FIG. 5 illustrates details of a portion of an example Bayesian inference network, which is applied here to evaluate the reliability of one or more recourse actions defined by the rules in the decision tree generated by the counterfactual algorithm.

In this example, the counterfactual method predicts the parameter Offset value for eventA3 (ReportConfigEUtraBestCellAnr_a3offsetAnrDelta_4) to be changed (to be greater than 1) to achieve favorable outcome. According to the inference network shown in FIG. 5, this offset value for eventA3 feature is influenced by (e.g., correlated with) the features CXC4012052_CPRICompressionwithBaseBandR-featurestate, qRxLevMin, and pZeroNominalPucch, the latter of which in turn is influenced by qRxLevMin and ReportConfigA1Prim_a1 ThresholdRsrpPrim_3.

A Bayesian-tree structure may be determined, for example, using a computing library such as bnlearn as described in the paper by Scutari. M (2010) entitled “Learning Bayesian Networks with the bnlearn R Package.” Journal of Statistical Software, 35 (3), 1-22.

The Bayesian tree supports causal analysis of ReportConfigEUtraBestCellAnr_a3offsetAnrDelta_4, for example. By querying the Bayesian tree, a confidence level (or score) for the counterfactual proposal of modifying ReportConfigEUtraBestCellAnr_a3offsetAnrDelta_4 can be derived by providing the values of the subset of parameters of the network data as input. In other words, the recourse method may comprise using the graph structure to determine a confidence level for the predicted

ReportConfigEUtraBestCellAnr_a3offsetAnrDelta_4, for example, by providing the values of the subset of network parameters for the target node (as example in this case, Retainability) and the ReportConfigEUtraBestCellAnr_a3offsetAnrDelta_4 usage for the target node to the Bayesian network and determining the confidence level in the proposed ReportConfigEUtraBestCellAnr_a3offsetAnrDelta_4 configuration. Multiple values between −10 and 10 can be tried for ReportConfigEUtraBestCellAnr_a3offsetAnrDelta_4, for example.

For example, a query might be: What is the confidence (or probability) of “Retainability” as >90% provided ReportConfigEUtraBestCellAnr_a3offsetAnrDelta_4=−1 and pZeroNominalPucch=−109? The answer returned by the system might be “0.98”. When the probability score is greater than a threshold probability, (e.g., the value of which may be set dependent on accuracy requirements), the counterfactual value proposed may be considered as a reliable value, since the Bayesian network structure is created based on historical network data that contains Retainability-related telemetry. Thus, if the confidence level is high, then the ReportConfigEUtraBestCellAnr_a3offsetAnrDelta_4feature can be considered as a reliable target for further recourse actions.

In this way, a Bayesian inference network may be used to validate output from the counterfactual model, in the manner of a consistency check as part of the recourse process. The inputs and outputs of the counterfactual model are provided to the Bayesian network and the Bayesian network provides a probability score that the input values are correct, given the relationships and correlations known to the Bayesian network through the nodes and edges therein. A Bayesian network used in this manner may ensure that any (unknown) biases in the counterfactual methods do not degrade network performance before the recourse action is performed.

In this example, a CFR method's recourse action module may then perform the parameter change (ReportConfigEUtraBestCellAnr_a3offsetAnrDelta_4) to the network (e.g., from 5 to −1) to see whether the achieved retainability meets the criterion for a favourable outcome.

Alternatives to Bayesian inference for the recourse algorithm include, but are not limited to, the following examples.
Actionable Recourse (AR) supports binary categorical features. Reference: Berk Ustun, Alexander Spangher, and Y. Liu. 2019. Actionable Recourse in Linear Classification. InProceedings of the Conference on Fairness, Accountability, and Transparency (FAT*).
CCHVAE—Reference: Pawelczyk, Martin, Klaus Broelemann and Gjergji Kasneci. “Learning Model-Agnostic Counterfactual Explanations for Tabular Data.” Proceedings of The Web Conference 2020 (2020).
CEM—Reference: Amit Dhurandhar, Pin-Yu Chen, Ronny Luss, Chun-Chen Tu, Paishun Ting, Karthikeyan Shanmugam, and Payel Das. 2018. Explanations based on the Missing: Towards Contrastive Explanations with Pertinent Negatives. In Advances in Neural Information Processing Systems344 (NeurIPS).
CLUE—Reference: Javier Antoran, Umang Bhatt, Tameem Adel, Adrian Weller, and José Miguel Hernández-Lobato. Getting a CLUE: A Method for Explaining Uncertainty Estimates. In International Conference on Learning Representations (ICLR).
DICE—Reference: R. K. Mothilal, Amit Sharma, and Chenhao Tan. 2020. Explaining machine learning classifiers through diverse counterfactual explanations.
Rafael Poyiadzi, Kacper Sokol, Raul Santos-Rodriguez, Tijl De Bie, and Peter Flach. 2020. In Proceedings of the AAAI/ACM Conference on AI, Ethics, and Society (AIES).
Growing Spheres—Reference: Thibault Laugel, Marie-Jeanne Lesot, Christophe Marsala, Xavier Renard, and Marcin Detyniecki. 2017. Inverse Classification for Comparison-based Interpretability in Machine Learning. arXiv preprint arXiv: 1712.08443 (2017).
Revise—Reference: Shalmali Joshi, Oluwasanmi Koyejo, Warut Vijitbenjaronk, Been Kim, and Joydeep Ghosh.2019. Towards Realistic Individual Recourse and Actionable Explanations in Black-BoxDecision Making Systems. arXiv preprint arXiv: 1907.09615 (2019).
Wachter—Reference: Sandra Wachter, B. Mittelstadt, and Chris Russell. 2017. Counterfactual Explanations Withoutpening the Black Box: Automated Decisions and the GDPR. Cybersecurity (2017).

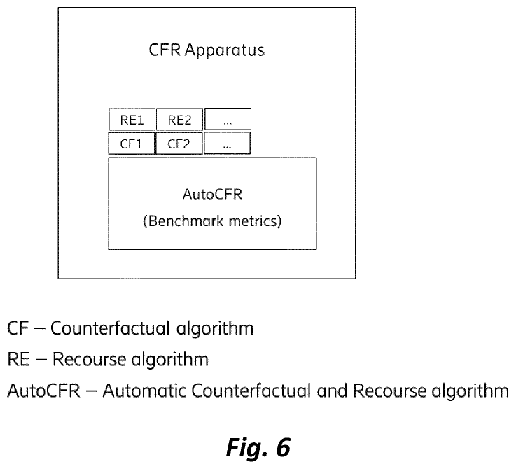

FIG. 6 illustrates elements of an example CFR apparatus, according to some embodiments of the techniques described herein. In this example, the RE and CF blocks represent available counterfactual and recourse algorithms, respectively, as discussed above. The illustrated apparatus further includes an AutoCFR algorithm, for selecting an appropriate algorithm for a particular data set. This may be implemented, for example, using the CARLA library, for example, as described in Pawelczyk, et al., “CARLA: A Python Library to Benchmark Algorithm Recourse and Counterfactual Explanation Algorithms.

The AutoCFR (Automatic counterfactual and recourse) algorithm is a framework that takes input data and applies it to multiple counterfactual (e.g.: CF1, CF2) and recourse algorithms (e.g.: RE1, RE2), to see the best counter factual and recourse algorithms among the available algorithms. The CFR apparatus shown in FIG. 2, for example, may have an AutoCFR library where all the available state of the art counterfactual and recourse algorithms are registered (including the methods proposed in this invention disclosure). The counterfactual method and recourse algorithm described herein may be part of this AutoCFR apparatus.

The AI/ML algorithm and its input data is registered with the AutoCFR module. The AutoCFR module evaluates the counterfactual and recourse algorithm for the given data, AI/ML algorithm and provides a best view with supporting benchmarking and evaluation metrics of evaluated CFR methods including the algorithms proposed herein.

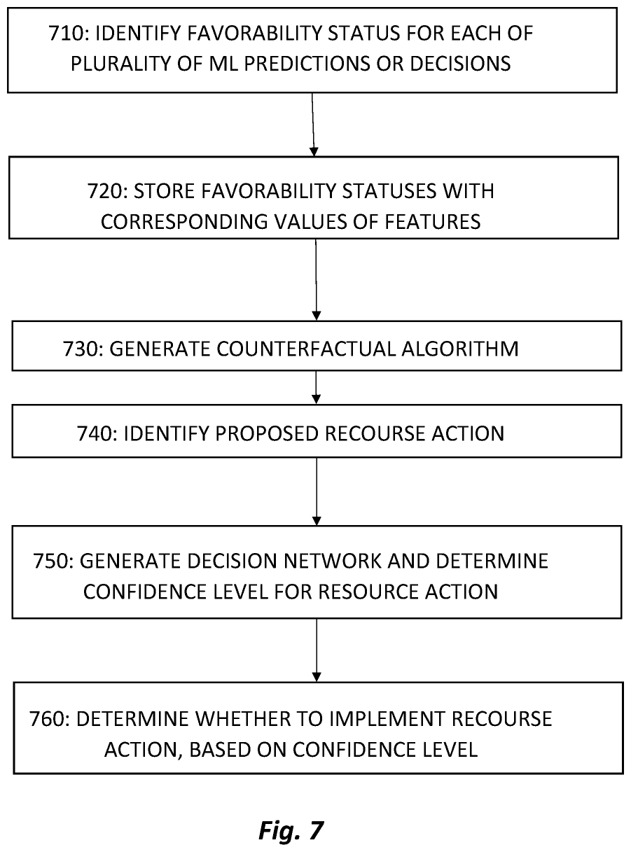

In view of the detailed examples and explanation provided above, it will be appreciated that FIG. 7 illustrates an example method for improving communication network performance, according to at least some of the techniques that were detailed above. It should be appreciated that the illustrated method is intended to encompass at least some of the CFR techniques described above, and thus where there are minor differences in the terminology used to describe the method shown in FIG. 7, this terminology should be understood as synonymous with or encompassing similar or related terms used in the preceding discuss.

In one embodiment, as shown at block 710, the method of FIG. 7 includes the step of identifying a favorability status of each of a plurality of predictions and/or decisions of a machine-learning algorithm acting on at least a portion of a communication network. In an alternative embodiment only a portion of individual predictions and/or decisions of a plurality of predictions and/or decisions of a machine-learning algorithm acting on at least a portion of a communication network may have their favorability status identified. For example, the method in one embodiment may select at random 75% of individual predictions and/or decisions and have their favorability status identified. Thus, the method monitors the outputs of a machine-learning algorithm, and records assessments of these outputs. As shown at block 720, the method further comprises storing these favorability statuses, along with corresponding values of network parameters used as input features in the machine-learning algorithm. Again, the term “favorability status” should be understood as referring to an indication of a degree of favorability for a prediction, decision, or other output of the machine-learning algorithm, e.g., a degree of closeness to one or more ideal values or ranges of values for one or more metrics or states characterizing the system. Identifying the favorability status might comprise calculating or computing the favorability status, in some embodiments, e.g., by comparing a numerical parameter to a threshold value to determine a binary favorable/unfavorable status, or by comparing a numerical parameter to each of several thresholds, to determine a numerical favorability status, or by calculating a metric representing a normalized degree of closeness of a numerical parameter or parameters to a target level, etc. For instance, if reducing power is a goal and the algorithm is predicting power, then a predicted power value that is greater than the 50^{th} percentile within a cluster or network might be labeled as (i.e., identified as) unfavorable, and otherwise labeled as favorable. In other embodiments or instances, the favorability status may be input by a user, e.g., based on an objective or subjective evaluation of some aspect of network performance by the user. The identified favorability status might be a binary one (“unfavorable” vs. “favorable”), for example, or a ranking or score, e.g., favorability ranked on a scale of 0-10.

As shown at block 730, the method further comprises the step of generating a counterfactual algorithm by generating a tree-based classification algorithm based on the stored favorability statuses and corresponding values of network parameters, to derive rules for producing a favorable status, based on one or more of the network parameters. As shown at block 740, at least one proposed recourse action is identified, based on the derived rules in the tree-based classification algorithm, where the proposed recourse action comprises a change in at least one of the network parameters.

As shown at block 750, the method still further comprises generating a Bayesian inference network and determining a confidence level estimating a reliability of achieving a favorable status by changing the at least one network parameter. Finally, as shown at block 760, the method further comprises determining whether to implement the proposed recourse action on the communication network, based on the confidence level. This may or may not involve human interaction, in various embodiments, and may comprise determining to implement the change in the at least one network parameter in response to determining that the confidence level equals or exceeds a threshold, for example.

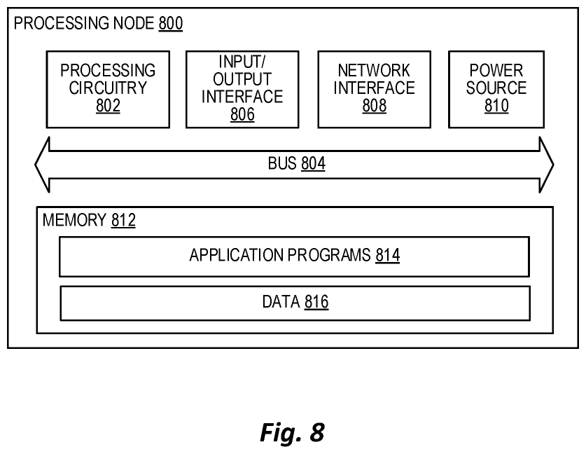

FIG. 8 illustrates an example processing node 800 in which all or parts of any of the techniques described above might be implemented. Processing node 800 may comprise various combinations of hardware and/or software, including a standalone server, a blade server, a cloud-implemented server, a distributed server, a virtual machine, container, or processing resources in a server farm. Processing node 800 may communicate with one or more radio access network (RAN) and/or core network nodes, in the context of a communications network, e.g., for collection of network performance data and/or for the monitoring and adjusting of network configuration parameters.

Processing node 800 includes processing circuitry 802 that is operatively coupled via a bus 804 to an input/output interface 806, a network interface 808, a power source 810, and a memory 812. Other components may be included in other embodiments.

Memory 812 may include one or more computer programs including one or more application programs 814 and data 816. Embodiments of the processing node 800 may utilize only a subset or all of the components shown. The application programs 814 may be implemented in a container-based architecture.

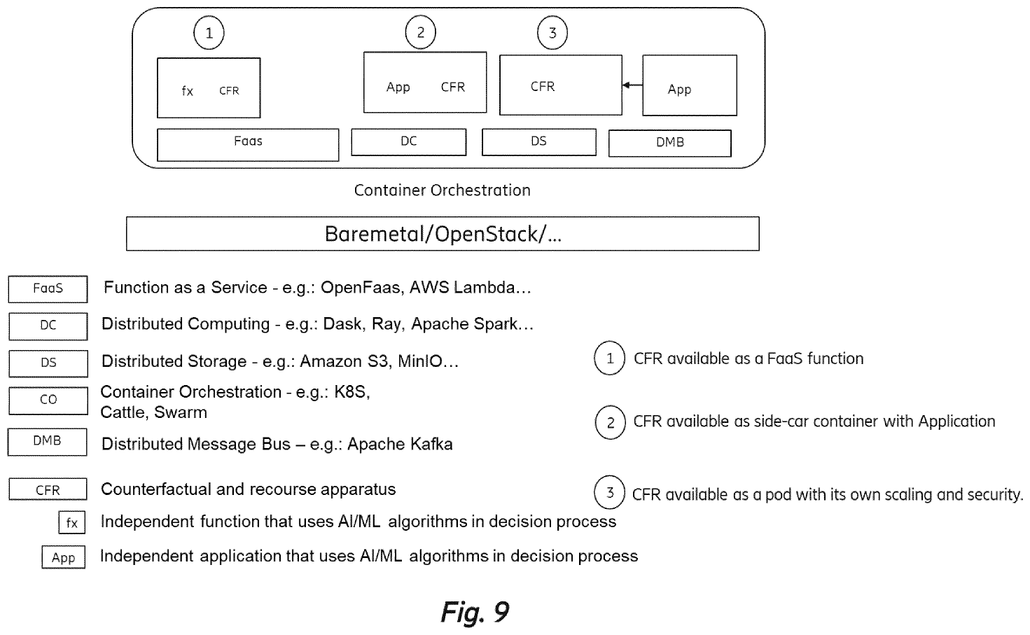

It will be appreciated that multiple processing nodes may be utilized to carry out any of the techniques described herein, e.g., by allocating different functions to different nodes. FIG. 9 illustrates several example cloud implementations. In a first example, for instance, various functions of the CFR algorithms described herein are implemented as Function-as-a-Service (FaaS) functions deployed in a serverless FaaS system. This option of deployment can be for both cloud and near edge platforms, where functions are built with CFR as additional functionalities are available with them. In a second example, the CFR implementation is available as a side-car container with application. This option of deployment can be for both cloud and near edge platform applications. Applications that prefer to do the life cycle management of CFR like it does for itself prefer this architecture. In a third option, CFR is available as pod with its own scaling and security. This option is the only option for edge devices to get CFR functionalities, as they are resource constrained. Also, this option is available for near edge and cloud as alternative architecture where applications and functions prefer to use a common pod rather than having a side car container.

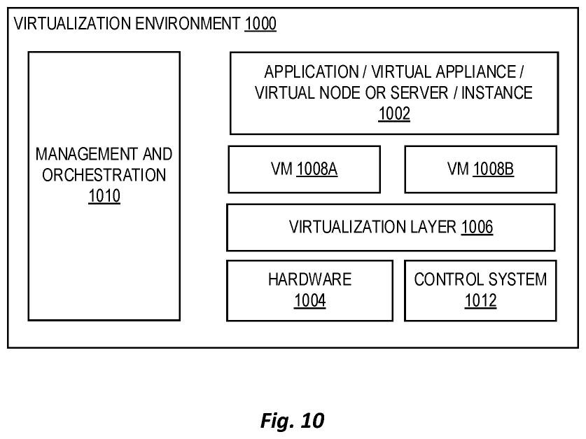

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g., such as in a data center or CPE) where many hardware nodes work together and are managed via management and orchestration 1010, which, among others, oversees lifecycle management of applications 1002.

The recourse-based techniques and systems described here help a communication network or other modeled system to progress towards a favorable outcome, rather than just providing a simple informational outcome (e.g.: prediction for given instance data. The network configurations modeled and/or managed by these techniques may include network configurations for any one or more of a core telecommunications network, a radio access network, a cloud data center, etc. The techniques provide a progressive and recourse-oriented approach, compared to current state of the art reinforcement learning (RL). In the case of RL, actions are performed on the environment, based on its past action's feedback (success or failure). The counterfactual methods described herein, on the other hand, use existing knowledge of the machine-learning model for feature-level recourse. The recommendations provided by these techniques builds trust with the user, as the system provides actionable insights that take the system towards a more favorable position, rather than a mere result. These techniques progress beyond “Explainable AI” (xAI), where the system is more transparent.

Another advantage of some embodiments of the techniques described herein is that data biases in the machine-learning algorithm can be detected by counterfactual explanation methods. With some embodiments of the techniques described herein, counterfactual explainers indicate feature-level prescriptions for further recourse. These feature-level prescriptions can potentially indicate data-level drifts or biases in the model. In the example of a machine-learning algorithm applied to human transactions, for instance, these prescriptions might reveal a preference in the model for a specific gender or race for a favorable outcome, e.g., if there are hidden race-specific or gender-specific features embodied in the machine-learning algorithms model. Corresponding biases might similarly be detected in communication networks, such that these biases can be mitigated with a human in the loop.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit or module, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. All publications referenced are incorporated herein by reference in their entireties.

1-28. (canceled)

29. A method for improving communication network performance, the method comprising:
identifying a favorability status of individual predictions and/or decisions of a plurality of predictions and/or decisions of a machine-learning algorithm acting on at least a portion of the communication network, and storing said favorability statuses along with corresponding values of network parameters used as features in the machine-learning algorithm;
generating a counterfactual algorithm based on the stored favorability statuses and corresponding values of network parameters, to derive rules for producing a favorable status, based on one or more of the network parameters;
identifying a proposed recourse action comprising a change in at least one of the network parameters, based on the rules derived in the counterfactual algorithm;
generating a decision network and determining a confidence level estimating a reliability of achieving a favorable status by changing the at least one network parameter; and
determining whether to implement the proposed recourse action on the communication network, based on the confidence level.

30. The method of claim 29, wherein the method comprises implementing the change in the at least one network parameter, in response to determining that the confidence level equals or exceeds a threshold.

31. The method of claim 29, wherein generating the counterfactual algorithm comprises generating a tree-based classification algorithm, based on the stored favorability statuses and corresponding values of network parameters, and wherein the derived rules correspond to branches in the tree-based classification algorithm.

32. The method of claim 29, wherein the counterfactual algorithm comprises one or more of any of the following:
a combinatorial optimization algorithm;
an evolutionary algorithm;
a random search algorithm;
a support-vector machine algorithm;
Pearl's causal model;
a variational autoencoder;
a shortest path algorithm on a graph; and
an integer programming technique.

33. The method of claim 29, wherein each of one or more of the favorability statuses is: represented as a binary value; or a numerical score representing a degree of favorability.

34. The method of claim 29, wherein identifying the favorability status of individual predictions and/or decisions of the plurality of predictions and/or decisions comprises collecting at least one favorability status from a user or operator of the communication system.

35. The method of claim 29, wherein identifying the favorability status of individual predictions and/or decisions of the plurality of predictions and/or decisions comprises computing at least one favorability status based on at least one threshold value and/or at least one target value for a performance metric.

36. A system for improving communication network performance, comprising one or more processing nodes, wherein the one or more processing nodes comprises processing circuitry and memory operatively coupled to the processing circuitry, whereby the one or more processing nodes are configured to:
identify a favorability status of individual predictions and/or decisions of a plurality of predictions and/or decisions of a machine-learning algorithm acting on at least a portion of the communication network, and storing said favorability statuses along with corresponding values of network parameters used as features in the machine-learning algorithm;
generate a counterfactual algorithm based on the stored favorability statuses and corresponding values of network parameters, to derive rules for producing a favorable status, based on one or more of the network parameters;
identify a proposed recourse action comprising a change in at least one of the network parameters, based on the rules derived in the counterfactual algorithm;
generate a decision network and determining a confidence level estimating a reliability of achieving a favorable status by changing the at least one network parameter; and
determine whether to implement the proposed recourse action on the communication network, based on the confidence level.

37. The system of claim 36, wherein the processing nodes are further configured to implement the change in the at least one network parameter, in response to determining that the confidence level equals or exceeds a threshold.

38. The system of claim 36, wherein the processing nodes are configured to generate the counterfactual algorithm by generating a tree-based classification algorithm, based on the stored favorability statuses and corresponding values of network parameters, and wherein the derived rules correspond to branches in the tree-based classification algorithm.

39. The system of claim 36, wherein the counterfactual algorithm comprises one or more of any of the following:
a combinatorial optimization algorithm;
an evolutionary algorithm;
a random search algorithm;
a support-vector machine algorithm;
Pearl's causal model;
a variational autoencoder;
a shortest path algorithm on a graph; and
an integer programming technique.

40. The system of claim 36, wherein each one or more of the favorability statuses is:
represented as a binary value; or a numerical score representing a degree of favorability.

41. The system of claim 36, wherein the processing nodes are configured to identify the favorability status of individual predictions and/or decisions of the plurality of predictions and/or decisions by collecting at least one favorability status from a user or operator of the communication system.

42. The method of claim 29, wherein the processing nodes are configured to identify the favorability status of individual predictions and/or decisions of the plurality of predictions and/or decisions by computing at least one favorability status based on at least one threshold value and/or at least one target value for a performance metric.

43. A processing node for a system for improving communication network performance, wherein the processing node comprises processing circuitry and memory operatively coupled to the processing circuitry, whereby the processing node is configured to:
identify a favorability status of individual predictions and/or decisions of a plurality of predictions and/or decisions of a machine-learning algorithm acting on at least a portion of the communication network, and storing said favorability statuses along with corresponding values of network parameters used as features in the machine-learning algorithm;
generate a counterfactual algorithm based on the stored favorability statuses and corresponding values of network parameters, to derive rules for producing a favorable status, based on one or more of the network parameters;
identify a proposed recourse action comprising a change in at least one of the network parameters, based on the rules derived in the counterfactual algorithm;
generate a decision network and determining a confidence level estimating a reliability of achieving a favorable status by changing the at least one network parameter; and
determine whether to implement the proposed recourse action on the communication network, based on the confidence level.

44. The processing node of claim 43, being further configured to implement the change in the at least one network parameter, in response to determining that the confidence level equals or exceeds a threshold.

45. The processing node of claim 43, being furhter configured to generate the counterfactual algorithm by generating a tree-based classification algorithm, based on the stored favorability statuses and corresponding values of network parameters, and wherein the derived rules correspond to branches in the tree-based classification algorithm.

46. The processing node of claim 43, wherein the counterfactual algorithm comprises one or more of any of the following:
a combinatorial optimization algorithm;
an evolutionary algorithm;
a random search algorithm;
a support-vector machine algorithm;
Pearl's causal model;
a variational autoencoder;
a shortest path algorithm on a graph; and
an integer programming technique.

47. The processing node of claim 43, wherein each one or more of the favorability statuses is: represented as a binary value; or a numerical score representing a degree of favorability.

48. The processing node of claim 43, being further configured to identify the favorability status of individual predictions and/or decisions of the plurality of predictions and/or decisions by collecting at least one favorability status from a user or operator of the communication system.
